(19) United States
(12) Patent Application Publication
(10) Pub. No.: US 2011/0237438 A1
(43) Pub. Date: Sep. 29, 2011

(54) EXTRACTION OF ORGANIC MATTER FROM NATURALLY OCCURRING SUBSTRATES

(76) Inventor: JOHN R. MARIHART, Fresno, CA (US)

(21) Appl. No.: 13/047,999

(22) Filed: Mar. 15, 2011

Related U.S. Application Data
(60) Provisional application No. 61/318,536, filed on Mar. 29, 2010.

(51) Int. Cl. A01N 25/00; C05F 11/00; A01P 3/00; A01P 21/00

(52) U.S. Cl. 504/358; 71/11; 514/784

(57) ABSTRACT

Natural organic-containing substrates such as leonardite, lignite, peat, shale, sediment and soil are treated with alkaline or suitable chelating agents as extractants for organic matter in the nature of soluble fulvic and humic acid fractions. The mixture containing naturally occurring substances and extractant is then transferred to a centrifuge to produce a sediment or settled phase and a supernatant phase. The yield of organic matter found in the supernatant phase following centrifugation is significantly greater than the corresponding yield obtained when the mixtures are allowed to settle under gravity in the absence of centrifugation.

### CROSS REFERENCE TO RELATED APPLICATIONS

This application claims the priority of prior provisional application No. 61/318,536 filed Mar. 29, 2010 by John R. Marihart.

### TECHNICAL FIELD

This disclosure relates to the extraction of organic matter compositions from naturally occurring substrates. More particularly, the disclosure deals with the extraction of organic matter compositions from naturally occurring humate-containing substrates such as leonardite, lignite, peat, shale, sediment and soil. Still more particularly, the disclosure relates to improving the yield of organic matter in the supernatant part of a mixture resulting from an alkaline extraction of the substrate. Organically rich compositions of this type are particularly useful in liquid fertilizers and compositions for modifying plant growth.

### BACKGROUND ART

Processes for extracting organic matter from naturally occurring substrates such as leonardite, lignite, peat, shale, sediment and soil via treatment with organic chelating agents as described in Marihart U.S. Pat. Nos. 4,698,090 and 4,786,307, incorporated herein by reference, and by alkaline extraction are well known in the prior art.

For example, humic substances may be extracted by treating particulate substrates such as leonardite with a solution of hydroxide, typically sodium hydroxide or potassium hydroxide. The resulting alkaline mixture generally consists of three fractions: (i) the humic acid fraction which remains in solution/suspension as the salt form of humic acid (typically sodium humate or potassium humate); (ii) the fulvic acid fraction which also remains in solution as the salt form (typically, sodium fulvate or potassium fulvate) and (iii) the humin fraction that is generally not soluble or extractable under these conditions. The mixture is generally allowed to remain in a tank for a period of time sufficient to settle the insoluble humin, twigs, pebbles, ash and other insoluble matter for removal. The supernatant is then separated from the settled material by decantation or suction.

Subsequently, the separated supernatant may be acidified (typically to pH 1.0-2.0) through the addition of a strong acid such as hydrochloric acid or sulfuric acid. The acidification causes the humic acid to precipitate while the fulvic acid fraction remains in solution.

The above Marihart U.S. patents disclose methods for extracting organic matter compositions from leonardite and other natural substrates. Disclosed are processes involving hot, alkaline solutions to extract compositions for plant growth modification. Similar compositions have been used to provide enhanced control of select fungal diseases in plants as well as enhanced plant nutrient uptake abilities as described in U.S. Pat. No. 6,911,415 issued to Ueland et al., also incorporated herein by reference.

### SUMMARY OF THE INVENTION

A method of increasing the yield of organic matter in supernatant resulting from an alkaline extraction of a natural substrate involves the following steps:

(a) mixing a naturally occurring substrate with an aqueous, alkaline solution to produce an alkaline mixture;

(b) agitating said alkaline mixture for a period of time;

(c) transferring said alkaline mixture into a centrifuge;

(d) centrifuging said alkaline mixture in the centrifuge producing a centrifugal force in the range of 20-25,000 Gs; and,

(e) collecting supernatant from the centrifuge.

### DETAILED DESCRIPTION

Aqueous solutions of sodium or potassium hydroxide were prepared and mixed with a granulated or particulate leonardite in a reaction vessel and heated to a temperature preferably maintained in the range of 160-190° F. for extraction of organic matter compositions from the leonardite. The separation is conducted in accordance with a centrifuging procedure described below which has been found to unexpectedly significantly increase the organic matter content of the supernatant as compared with traditional settling separation methods. In some trials sodium hydroxide was used as the alkaline medium and in other trials potassium hydroxide was used. The above range of temperature maintained in the reaction vessel is preferred but not critical and temperatures in the range of 70°-220° F. are considered to produce comparable results.

The contents of the reaction vessel were agitated by stirring for about seven hours to achieve a uniform mixture. A uniform mixture may be obtained by other forms of agitation besides stirring. While the mixture was being stirred it was maintained in the above temperature range and was then transferred by pumping through a decanting centrifuge which may be operated to produce a centrifugal force in the range of 20-25,000 Gs (G force represents the force of gravity). The presently preferred decanting centrifuge is a continuous flow Alpha Laval P2-500 model which is capable of rotating at up to 3650 revolutions per minute (rpm) producing a centrifugal force of 3574 Gs. Other centrifuges may yield similar results. Typical rates of pumping through this centrifuge were in the range of 30 to 100 gpm (gallons per minute); however, rates of pumping within a broader range of from 10-500 gpm may be practical depending on the desired quantity of production, costs of equipment, operating costs and other factors. Greater rates of pumping generally result in less time of residence in a selected centrifuge thereby requiring higher G forces obtained by higher speeds of rotation of the centrifuge. Residence time in the Alpha Laval P2-500 centrifuge is believed to be only a few seconds The supernatant exiting the centrifuge was then pumped to a storage tank for further processing. The extracted material in the supernatant resulting from the centrifugation step consists of a mixture rich in dissolved and suspended organic matter constituents and has organic matter concentration over 30% higher than is achieved with conventional settling processes.

Centrifugation can be expected to more efficiently remove humin and other insoluble materials but has not previously been thought to be commercially viable due to the significant capital investment and power requirements to operate centrifuge equipment. However, the unexpected over 30% improvement in organic matter yield in the supernatant resulting from centrifugal separation rather than conventional settling is commercially significant. The following table shows results comparing the concentrations of organic matter in the supernatants extracted from various naturally occurring substrates. The concentrations of organic matter given in the table and the concentrations of organic matter specified in the claims are expressed in term of parts per million (ppm) of carbon in the supernatant. The quantity of organic matter in the supernatant relates directly to the concentration of organic carbon found in the supernatant.

| Settled Product | Centrifuged Product |
|---|---|
| 7.6 | 9.5 |
| 7.9 | 9.1 |
| 7.0 | 9.4 |
| 7.4 | 8.2 |
| 6.1 | 9.3 |
| 6.4 | 9.0 |
| 5.8 | 9.0 |
| 5.6 | 8.9 |
| Avg. 6.7 | Avg. 9.0 = 34% increase |

In the current experimentation, centrifugation was used to speed up the separation process and thus increase throughput in the manufacturing process. The alkaline mixture was pumped through the centrifuge to rapidly effect a separation into a supernatant phase and a settled, solid phase. The resulting supernatant phase was then passed to a storage container for further processing.

The above table shows the enhanced yield of organic matter in the supernatant when centrifugation is used compared to when settling under gravity was used. It would normally be expected that centrifugation would lead to more efficient removal of humin and other alkali-insoluble materials from the alkaline mixture (and thus decrease the amount of organic matter in the supernatant). It would not be expected that centrifugation of the alkaline mixture would achieve the opposite result, that is, an increased yield of organic matter in the supernatant compared to a similar extraction involving settling under gravity. But that is in fact what happened, a significantly improved yield of organic matter in the supernatant was observed following centrifugation. Such a result is counter-intuitive.

The unexpected improvement in organic matter yield in the supernatant resulting from centrifugal separation is commercially significant. The large-scale use of centrifugation in the extraction of organic matter from naturally occurring substrates has not been previously considered commercially viable due to the significant capital investment and power requirements to operate centrifugation equipment. In the current experimentation, centrifugation was initially used for the purpose of speeding up the separation process and thus increase throughput in the manufacturing process. The observed increase in the organic matter yield in the supernatant provides an additional significant economic advantage to the use of centrifugation in such extraction.

In summary, the use of centrifugation to increase throughput in the manufacture of agricultural products from leonardite and other naturally occurring substrates unexpectedly produced an added bonus of a very significantly increased yield of organic matter in desired supernatant product. The increased yield is significant economically and a corresponding decrease in the amount of settled matter diminishes the waste disposal problem.

The reasons for this observed increase in organic matter yield in the alkaline supernatant following centrifugation are not yet fully understood. While not wishing to be bound by any explanation, hypothesis or theory as to why centrifugation leads to an increased yield of organic matter in the supernatant, it is speculated that immediately following the alkaline extraction, the supernatant may contain constituents that promote the precipitation of some organic matter components. When the system is allowed to settle under gravity without the use of centrifugation these constituents have sufficient time to act as precipitating agents and thus lead to a decrease in the organic matter content of the supernatant. On the other hand when centrifugation is used, these constituents may be rapidly centrifuged out of the mixture and would not have time to promote precipitation of other parts of the organic matter from the supernatant.

Supernatant rich in organic material produced in accordance with the processes disclosed above can be sprayed, broadcast or otherwise applied to soil or plants preferably in liquid form by adding the supernatant to an aqueous medium to produce an aqueous mixture. The liquid mixture may also contain an agricultural product selected from the group consisting of a fertilizer, a fungicide, a plant growth promoter and any mixture thereof for application to soil and/or plants to promote plant health and growth. The aqueous mixture may also be applied to soil or plants on a dry carrier such as a fertilizer material or other dry substrate containing plant growth promoting or regulating ingredients.

The present invention is presented and described in what are considered to be the most practical and preferred embodiment. It is recognized, however, that departures may be made therefrom which are within the scope of this invention, and that obvious modifications will occur to one skilled in the art upon reading this disclosure. The temperatures, specific centrifuge used, flow rates and g-values in centrifugation as provided above as intended to be exemplary and not limiting.

I claim:

1. A method of increasing the yield of organic matter in supernatant resulting from an alkaline extraction of a naturally occurring substrate, the method comprising the steps of:
(a) mixing a naturally occurring, organic matter-containing substrate with an aqueous, alkaline solution to produce an alkaline mixture;
(b) agitating said alkaline mixture for a period of time;
(c) transferring said alkaline mixture into a centrifuge;
(d) centrifuging said alkaline mixture in the centrifuge producing centrifugal force in the range of 20-25,000 Gs; and,
(e) collecting supernatant from the centrifuge.

2. The method of claim 1 wherein said naturally occurring substrate is selected from the group consisting of leonardite, lignite, peat, shale, sediment and soil and any combination thereof.

3. The method of claim 1 wherein the alkaline mixture is agitated for about seven hours and the temperature of said alkaline mixture is maintained in the range of 70°-220° F. during agitation.

4. The method of claim 1 wherein the centrifuge is operated to produce a centrifugal force in the range of 20-25,000 G's.

5. The method of claim 1 wherein the rate at which said alkaline mixture is transferred to the centrifuge at a rate in the range of 10 to 500 gallons per minute.

6. The supernatant produced by the method of claim 1 having a concentration of organic matter therein of not less than 8.2 parts per million of carbon.

7. A method of using the supernatant of claim 6 comprising the steps of:
a) mixing said supernatant with an aqueous medium containing an agricultural product selected from the group consisting of a fertilizer, a fungicide, a plant growth promoter and any mixture thereof to produce an aqueous product; and
b) applying said aqueous product to soil and/or plants to promote plant growth.

8. A method of using the supernatant of claim 6 comprising the steps of:
a) mixing said supernatant with an aqueous medium containing an agricultural product selected from the group consisting of a fertilizer, a fungicide, a plant growth promoter and any mixture thereof to produce a dry agricultural product; and
b) applying said dry agricultural product to soil and/or plants to promote plant growth.

9. A method of increasing the yield of organic matter in supernatant resulting from an alkaline extraction of leonardite, the method comprising the steps of:
(a) mixing a quantity of particulate leonardite with an aqueous solution of potassium hydroxide to produce an alkaline mixture;
(b) agitating said alkaline mixture for about seven hours;
(c) transferring said alkaline mixture into a centrifuge;
(d) centrifuging said alkaline mixture in the centrifuge producing centrifugal force in the range of 20-25,000 Gs; and,
(e) collecting supernatant from the centrifuge.

10. The method of claim 9 wherein said alkaline mixture is agitated for about seven hours while maintained at a temperature in the range of 160°-190° F.

11. The method of claim 9 wherein said alkaline mixture is pumped to the centrifuge at a rate in the range of 30 to 100 gallons per minute.

12. The method of claim 11 wherein the centrifuge is operated to produce a centrifugal force of about 2850 Gs.

13. The supernatant produced by the method of claim 9 having a concentration of organic matter therein of not less than 8.2 parts per million of carbon.

14. A method of using the supernatant of claim 13 comprising the steps of:
a) mixing said supernatant with an aqueous medium containing an agricultural product selected from the group consisting of a fertilizer, a fungicide, a plant growth promoter and any mixture thereof to produce an aqueous product; and
b) applying said aqueous product to soil and/or plants to promote plant growth.

15. A method of using the supernatant of claim 13 comprising the steps of:
a) mixing said supernatant with an aqueous medium containing an agricultural product selected from the group consisting of a fertilizer, a fungicide, a plant growth promoter and any mixture thereof to produce a dry agricultural product; and
b) applying said dry agricultural product to soil and/or plants to promote plant growth.

16. A method of increasing the yield of organic matter in supernatant resulting from an alkaline extraction of leonardite, the method comprising the steps of:
(a) mixing a quantity of particulate leonardite with an aqueous solution of sodium hydroxide to produce an alkaline mixture;
(b) agitating said alkaline mixture for about seven hours;
(c) transferring said alkaline mixture into a centrifuge;
(d) centrifuging said alkaline mixture in the centrifuge producing centrifugal force in the range of 20-25,000 Gs; and,
(e) collecting supernatant from the centrifuge.

17. The method of claim 16 wherein said alkaline mixture is agitated for about seven hours while maintained at a temperature in the range of 160°-190° F.

18. The method of claim 16 wherein said alkaline mixture is pumped to the centrifuge at a rate in the range of 30 to 100 gallons per minute.

19. The method of claim 18 wherein the centrifuge is operated to produce a centrifugal force of about 2850 Gs.

20. The supernatant produced by the method of claim 16 having a concentration of organic matter therein of not less than 8.2 parts per million of carbon.

21. A method of using the supernatant of claim 20 comprising the steps of:
a) mixing said supernatant with an aqueous medium containing an agricultural product selected from the group consisting of a fertilizer, a fungicide, a plant growth promoter and any mixture thereof to produce an aqueous product; and
b) applying said aqueous product to soil and/or plants to promote plant growth.

22. A method of using the supernatant of claim 20 comprising the steps of:
a) mixing said supernatant with an aqueous medium containing a composition selected from the group consisting of a fertilizer, a fungicide, a plant growth promoter and any mixture thereof to produce an agricultural product;
b) drying said agricultural product; and
c) applying said agricultural product to soil and/or plants to promote plant growth.
